(19) United States
(12) Patent Application Publication
(10) Pub. No.: US 2007/0068279 A1
(43) Pub. Date: Mar. 29, 2007

(54) Device for determining the position and a torque of a shaft

(76) Inventor: Wolfgang Abele, Spraitbach (DE)

Correspondence Address: KENYON & KENYON LLP, ONE BROADWAY, NEW YORK, NY, 10004, US

(21) Appl. No.: 11/502,843

(22) Filed: Aug. 11, 2006

(30) Foreign Application Priority Data
Aug. 11, 2005 (DE) 10 2005 037 938.9

(51) Int. Cl. G01L 3/00

(52) U.S. Cl. 73/862.08

(57) ABSTRACT

A device for determining the position and a torque of a shaft, e.g., a steering control shaft of a steering system, includes: a first signal generation device on a first shaft section of the shaft, the first signal generation device emitting a first and second signal sequence to a first evaluation device; and a second shaft section on which a second signal generation device is arranged, which emits a third and fourth signal sequence to a second evaluation device. In order to arrange a device for determining the position and a torque of a shaft that allows reliable and precise determination of the position and the torque, the signals from the first and the second signal generation device are simultaneously recorded across the entire particular geometric extension of the signal generation devices by the first and/or the second evaluation device, and the position of the shaft is determined.

### CROSS-REFERENCE TO RELATED APPLICATION

The present application claims priority to Application No. 10 2005 037 938.9, filed in the Federal Republic of Germany on Aug. 11, 2005, which is expressly incorporated herein in its entirety by reference thereto.

### FIELD OF THE INVENTION

The present invention relates to a device for determining the position and a torque of a shaft.

### BACKGROUND INFORMATION

European Published Patent Application No. 0 914 590 describes a device for determining the position of a rotating shaft having a two-pole ring magnet element, which is connected to the shaft in a torsionally fixed manner, and a stator element, made of a magnetically conductive material, inside of which the ring magnet element is disposed. Three air gaps, which are offset at an identical angle, are introduced in the ring magnet element, and an individual Hall-IC element, which emits forward-voltage measuring values upon rotation of the ring magnet element relative to the stator element, is arranged in two adjacently located air gaps.

A single evaluation device records a Hall IC voltage characteristic measured by each Hall-IC element and assigns it a positional angle of the shaft. The evaluation device calculates the actual positional angle of the shaft from the forward-voltage measuring values it receives.

The device is believed to be unsuitable for safety-critical tasks since it is not configured for redundancy.

German Published Patent Application No. 100 60 287 describes a device for determining the position and a torque of a shaft having a first signal-generation device made up of a first and second track of code arrays on a first shaft section of the shaft, which emits a first and second signal sequence to a first evaluation device; and a second shaft section, fixed in place via a torsion element on the first shaft section, where a second signal generation device is located, which emits a third and fourth signal sequence to a second evaluation device via a third and fourth track of code arrays.

The evaluation devices are not interconnected in redundant fashion, and the evaluation devices merely tap signals measured in a punctual manner, so that the measuring accuracy is able to be increased as well.

### SUMMARY

Example embodiments of the present invention provide a device for determining the position and a torque of a shaft, which may allow a reliable and very precise determination of the position and the torque.

Since the first and/or second evaluation device record(s) the signals of the first and second signal generation device across the entire particular geometric extension or across the radian measure of the signal generation devices, the first and second evaluation devices being interconnected in a redundant and signal-transmitting manner, a rotary, always complete recording of the signals of the signal generation devices such as from, for example, inductive signal generation devices formed as a ring of coils arranged side-by-side or from multi-pole rings, is possible on the one hand, and an average value generation is possible as well; on the other hand, a single evaluation device is still able to record measuring values and to implement an angle calculation should another become unavailable. The signal generation devices may be moveable via the shaft. The evaluation devices are stationary. However, it may also be provided to arrange the signal generation devices as stationary devices, and to arrange the evaluation devices as moveable via the shaft.

In order to be able to determine a torque in the shaft, a torsion element is disposed between the first shaft section and the second shaft section. The torque is determined by the angle difference of the two measured angles of the first and second signal generation devices and the known torsional stiffness of the torsion element. The first evaluation device and the second evaluation device, or the first or the second evaluation device by itself, are/is able to determine the torque. The evaluation devices may be arranged as microprocessors or as user-computer circuit, also referred to as ASIC. They include at least one arithmetic unit (CPU), which is linked to a memory component. The arithmetic unit has an A/D converter on the input side, and, e.g., a D/A converter or a CAN bus interface on the output side. A number of sensors, which detect the signals of the first and/or second signal generation device and are connected to the A/D converter, are part of the evaluation devices.

The at least four signal sequences are generated by optical or field-generating, e.g., inductive, or field-modifying code arrays, which generate a different signal frequency or signal periodicity during rotation of the shaft, or which are differentiated by the generation of different fields, e.g., by a different field pole number.

The code arrays of the first and/or second signal generation device may generate a periodically changing electric or magnetic field. The code arrays may be arranged as a ring of coils arranged side-by-side, or as a multi-pole wheel or multi-pole ring, a multi-pole wheel or multi-pole ring including an array of structures that have alternating inverse poles, or also include field-generating and non-field-generating sections or structures. When using GMR sensors in the evaluation devices, it may be provided to form the respective signal sequences of the first signal generation device and the second signal generation device by a first code array or a ring of coils arranged next to each other, or as multi-pole ring around the shaft, using a scale graduation marking n, and to form the respective second code array or multi-pole ring around the shaft using a scale graduation marking n+1. The position or the angle of rotation of the first shaft section is determined by the first and second signal sequence, and the position of the second shaft section is determined by the third and fourth signal sequence, via a nonius method, the different number of structures or pole pairs on the first and second code array and the third and fourth code array causing a phase shift.

The torque in the shaft and, e.g., in the torsion element may be ascertained redundantly by determining the angle difference between the code arrays of the first and the second signal generation device having identical structure or pole numbers. This is the angle difference between the first and third signal sequence and between the second and fourth signal sequence.

If an interference variable that is significant for the particular angle of rotation is superposed to the torque signal or the torque characteristic across an angle of rotation of 360°, or if the device already has a system-immanent interference variable, this allows the determined torque to be compensated by an evaluation device as a function of the shaft position. In general, the interference variable is a systematic, progressive or degressive sensor fault.

Since each shaft section has a signal generation device, it is possible to determine a particular absolute angle of the individual shaft sections, and not only to form a difference of the angles of rotation of the shaft sections. This in makes it possible to determine whether a torque is applied to the first shaft section or to the second shaft section.

If the shaft is a steering control shaft in an auxiliary steering system of a passenger car or a commercial motor vehicle, this consequently provides the possibility of supplying information to a control, which allows an active stabilization of a vehicle, for example.

According to an example embodiment of the present invention, a device for determining a position and a torque of a shaft includes: a first signal generation device arranged on a first shaft section of the shaft, the first signal generation device adapted to emit a first signal sequence and a second signal sequence to a first evaluation device; and a second signal generation device arranged on a second shaft section, the second signal generation device adapted to emit a third signal sequence and a fourth signal sequence to a second evaluation device. At least one of (a) the first evaluation device and (b) the second evaluation device is adapted to simultaneously record signals of the first signal generation device and the second signal generation device across an entire particular geometric extension of the first signal generation device and the second signal generation device and to determine the position of the shaft.

The shaft may be arranged as a steering control shaft of a steering system.

The first shaft section may be connected to the second shaft section by a torsion element, and at least one of (a) the first evaluation device and (b) the second evaluation device may be adapted to determine the torque in the shaft.

The signal sequences may include at least one of (a) optical, (b) field-generating and (c) field-modifying code arrays.

At least one of (a) the first signal generation device and (b) the second signal generation device may include at least one of (a) optical, (b) field-generating and (c) field-modifying code arrays having at least one of (a) different signal periodicity and (b) numbers of structures of the particular code array.

At least one field-modifying code array of at least one of (a) the first signal generation device and (b) the second signal generation device may include a periodically changing at least one of (a) an electrical field and (b) a magnetic field.

The first signal generation device may include an array of at least one of (a) a plurality of coils, (b) a multi-pole wheel and (c) a multi-pole ring.

A position of the first shaft section may be determinable by the first and second signal sequence, and a position of the second shaft section may be determinable by the third and fourth signal sequence in accordance with a nonius method.

The torque of the shaft may be determinable from an angle difference in accordance with at least one of (a) the first and third signal sequence and (b) the second and fourth signal sequence.

A torque characteristic across 360° may be significantly superposed by an interference variable.

A torque characteristic across 360° may be significantly superposed by a system-related interference variable.

At least one of the evaluation devices may be adapted to compensate the torque as a function of at least one of (a) the position and (b) an angle of rotation of the shaft.

At least one of (a) the first evaluation device and (b) the second evaluation device may be adapted to detect whether a torque is introduced at at least one of (a) the first shaft section and (b) the second shaft section.

The device may be arranged in a steering system in one of (a) a passenger car and (b) a commercial motor vehicle.

The may be arranged in an auxiliary steering system in one of (a) a passenger car and (b) a commercial motor vehicle.

According to an example embodiment of the present invention, a device for determining a position and a torque of a shaft includes: a first evaluation device; a second evaluation device; a first signal generation device arranged on a first shaft section of the shaft, the first signal generation device adapted to emit a first signal sequence and a second signal sequence to the first evaluation device; and a second signal generation device arranged on a second shaft section, the second signal generation device adapted to emit a third signal sequence and a fourth signal sequence to the second evaluation device. At least one of (a) the first evaluation device and (b) the second evaluation device is adapted to simultaneously record signals of the first signal generation device and the second signal generation device across an entire particular geometric extension of the first signal generation device and the second signal generation device to determine the position of the shaft.

Example embodiments of the present invention are described in greater detail with reference to the appended Figures.

### BRIEF DESCRIPTION OF THE DRAWINGS

FIG. 1 is a schematic longitudinal cross-sectional view through a device for determining the position and a torque in a steering control shaft.

FIG. 2 illustrates a signal sequence of the signal generation devices of the device illustrated in FIG. 1.

FIG. 3 is a schematic overview of the redundant possibilities of determining the position and the torque in the steering control shaft illustrated in FIG. 1.

FIG. 4 is a schematic overview of the redundant linking of the signal generation devices and evaluation devices of the device illustrated in FIG. 1.

### DETAILED DESCRIPTION

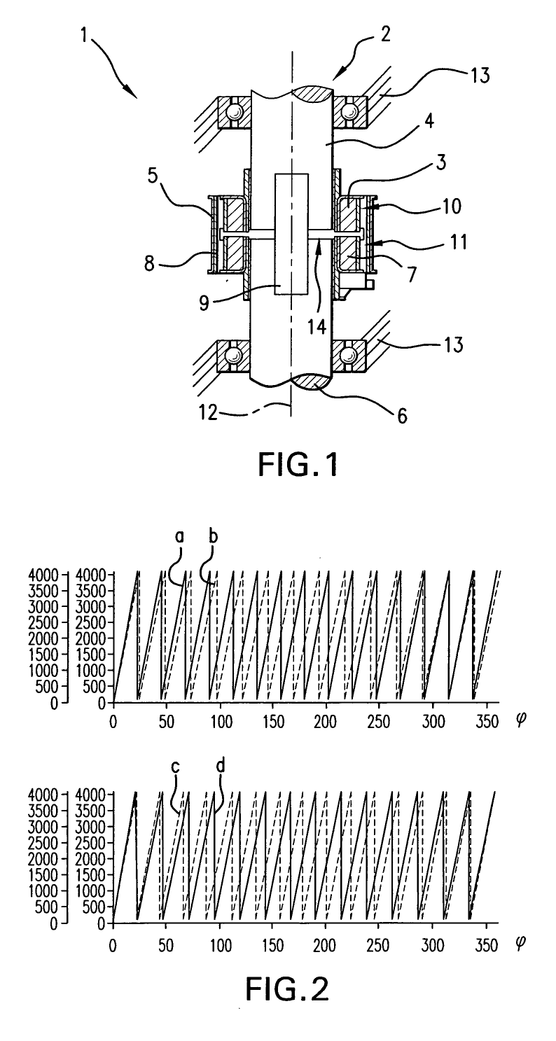

A device 1 for determining the position and a torque in shaft 2 is illustrated in FIG. 1 as a schematic longitudinal cross-section along a longitudinal axis 12 of shaft 2. Shaft 2 is a steering control shaft in an auxiliary steering system of a motor vehicle and includes a first shaft section 4, which is connected to a steering handle in a torsionally fixed manner, and a second shaft section 6, which is connected to an input member or pinion of a steering gear in a torsionally fixed manner.

First and second shaft sections 4, 6 are joined to each other via a torsion element 9 having a known torsional stiffness. Shaft 2 is supported in a steering column housing 13.

In plane of intersection 14 between first and second shaft section 4, 6, respectively, steering column housing 13 is used to fix in place a first and second evaluation device 5, 8, respectively. Evaluation devices 5, 8 are fixed in place on steering column housing 13, with radial clearance around shaft 2 and around a first signal generation device 3, which is disposed in a manner allowing rotation with first shaft section 4; and about a second signal generation device 7, which is disposed in a manner allowing rotation with second shaft section 6.

Evaluation devices 5, 8 include sampling sensor elements or sensor arrays of AMR or GMR sensors, which are connected to an ASIC via A/D converters. For each evaluation device 5, 8, an ASIC and a sensor array are disposed about the circumference of shaft 2 on steering column housing 13.

First signal generation device 3 and second signal generation device 7 are arranged around the axial ends of first and second shaft sections 4, 6, respectively, in the form of rings of coils 10, 11 arranged side-by-side.

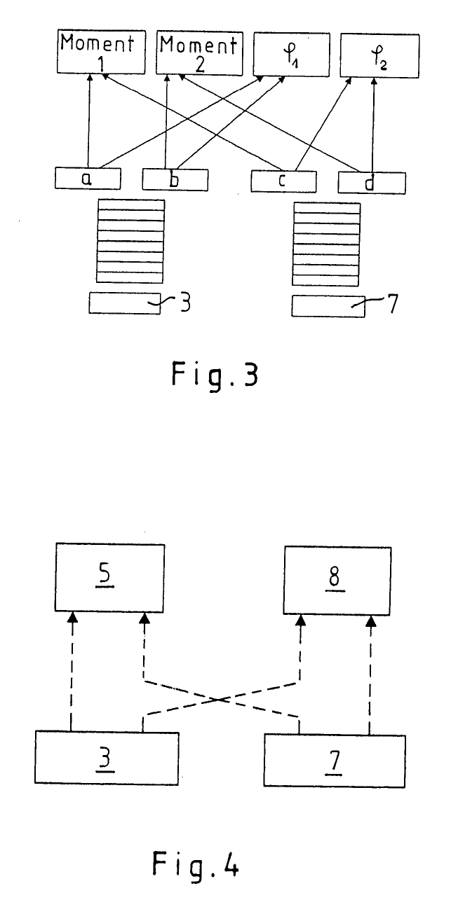

Each ring of coils 10, 11 arranged side-by-side includes a first and a second code array. In each instance, one code array of first signal generation device 3 and second signal generation device 7 has 15 coils, and one code array has 16 coils. The code array having 15 coils yields a first signal sequence a upon rotation of shaft 2 (cf., FIG. 2), and the code array having 16 coils yields a second signal sequence b. The code array having 15 coils of second signal generation device 7 yields a third signal sequence c upon rotation of shaft 2, and the code array having 16 coils yields a fourth signal sequence d (cf., also FIG. 3). As indicated by FIG. 2, a phase offset comes about in each signal sequence determined by respective evaluation device 5, 8, which increases with increasing angle of rotation φ of the shaft. This phase difference may be evaluated using, e.g., a conventional nonius method.

As indicated in FIG. 3, angle of rotation φ of second shaft section 6 is determined by analyzing third and fourth signal sequence c, d, respectively.

The torque in shaft 2 is determined redundantly, in duplicate, by analyzing first and third signal sequence a, c, respectively, and third and fourth signal sequence b, d, respectively. As indicated in FIG. 4, it is possible to determine the position and to determine the torque in shaft 2 even when one evaluation device or one ASIC is unavailable, by linking each signal generation device to each evaluation device.

LIST OF REFERENCE NUMERALS

| | | | |
|---|---|---|---|
| 1 | device | 26 | |
| 2 | shaft | 27 | |
| 3 | signal generation device, first | 28 | |
| 4 | shaft section, first | 29 | |
| 5 | evaluation device, first | 30 | |
| 6 | shaft section, second | 31 | |
| 7 | signal generation device, second | 32 | |
| 8 | evaluation device, second | 33 | |
| 9 | torsion element | 34 | |
| 10 | coils | 35 | |
| 11 | coils | 36 | |
| 12 | longitudinal axis, of 2 | 37 | |
| 13 | steering column housing | 38 | |
| 14 | plane of intersection | 39 | |
| 15 | | 40 | |
| 16 | | 41 | |
| 17 | | 42 | |
| 18 | | 43 | |
| 19 | | 44 | |
| 20 | | 45 | |
| 21 | | 46 | |
| 22 | | 47 | |
| 23 | | 48 | |
| 24 | | 49 | |
| 25 | | 50 | |
| a | signal sequence, first | φ | angle of rotation |
| b | signal sequence, second | | |
| c | signal sequence, third | | |
| d) | signal sequence, fourth | | |

What is claimed is:

1. A device for determining a position and a torque of a shaft, comprising:
a first signal generation device arranged on a first shaft section of the shaft, the first signal generation device adapted to emit a first signal sequence and a second signal sequence to a first evaluation device; and
a second signal generation device arranged on a second shaft section, the second signal generation device adapted to emit a third signal sequence and a fourth signal sequence to a second evaluation device;
wherein at least one of (a) the first evaluation device and (b) the second evaluation device is adapted to simultaneously record signals of the first signal generation device and the second signal generation device across an entire particular geometric extension of the first signal generation device and the second signal generation device and to determine the position of the shaft.

2. The device according to claim 1, wherein the shaft is arranged as a steering control shaft of a steering system.

3. The device according to claim 1, wherein the first shaft section is connected to the second shaft section by a torsion element, at least one of (a) the first evaluation device and (b) the second evaluation device adapted to determine the torque in the shaft.

4. The device according to claim 1, wherein the signal sequences include at least one of (a) optical, (b) field-generating and (c) field-modifying code arrays.

5. The device according to claim 1, wherein at least one of (a) the first signal generation device and (b) the second signal generation device include at least one of (a) optical, (b) field-generating and (c) field-modifying code arrays having at least one of (a) different signal periodicity and (b) numbers of structures of the particular code array.

6. The device according to claim 5, wherein at least one field-modifying code array of at least one of (a) the first signal generation device and (b) the second signal generation device includes a periodically changing at least one of (a) an electrical field and (b) a magnetic field.

7. The device according to claim 1, wherein the first signal generation device includes an array of at least one of (a) a plurality of coils, (b) a multi-pole wheel and (c) a multi-pole ring.

8. The device according to claim 1, wherein a position of the first shaft section is determinable by the first and second signal sequence and a position of the second shaft section is determinable by the third and fourth signal sequence in accordance with a nonius method.

9. The device according to claim 1, wherein the torque of the shaft is determinable from an angle difference in accordance with at least one of (a) the first and third signal sequence and (b) the second and fourth signal sequence.

10. The device according to claim 9, wherein a torque characteristic across 360° is significantly superposed by an interference variable.

11. The device according to claim 9, wherein a torque characteristic across 360° is significantly superposed by a system-related interference variable.

12. The device according to claim 9, wherein at least one of the evaluation devices is adapted to compensate the torque as a function of at least one of (a) the position and (b) an angle of rotation of the shaft.

13. The device according to claim 1, wherein at least one of (a) the first evaluation device and (b) the second evaluation device is adapted to detect whether a torque is introduced at at least one of (a) the first shaft section and (b) the second shaft section.

14. The device according to claim 1, wherein the device is arranged in a steering system in one of (a) a passenger car and (b) a commercial motor vehicle.

15. The device according to claim 1, wherein the device is arranged in an auxiliary steering system in one of (a) a passenger car and (b) a commercial motor vehicle.

16. A device for determining a position and a torque of a shaft, comprising:
a first evaluation device;
a second evaluation device;
a first signal generation device arranged on a first shaft section of the shaft, the first signal generation device adapted to emit a first signal sequence and a second signal sequence to the first evaluation device; and
a second signal generation device arranged on a second shaft section, the second signal generation device adapted to emit a third signal sequence and a fourth signal sequence to the second evaluation device;
wherein at least one of (a) the first evaluation device and (b) the second evaluation device is adapted to simultaneously record signals of the first signal generation device and the second signal generation device across an entire particular geometric extension of the first signal generation device and the second signal generation device to determine the position of the shaft.
